(19) United States
(12) Patent Application Publication
(10) Pub. No.: US 2022/0038974 A1
(43) Pub. Date: Feb. 3, 2022

(54) INTER-FREQUENCY CELL RESELECTION IN NEW RADIO UNLICENSED

(71) Applicant: MediaTek Singapore Pte. Ltd., Singapore (SG)

(72) Inventors: Abhishek ROY, San Jose, CA (US); Pavan Santhana Krishna NUGGEHALLI, San Jose, CA (US)

(21) Appl. No.: 17/277,398

(22) PCT Filed: Oct. 29, 2019
(86) PCT No.: PCT/US2019/058494

§ 371 Date: Mar. 18, 2021

Related U.S. Application Data
(60) Provisional application No. 62/753,115, filed on Oct. 31, 2018.

(51) Int. Cl. H04W 36/08; H04W 36/22; H04W 36/00

(52) U.S. Cl. CPC H04W 36/08; H04W 36/22; H04W 84/042; H04W 36/00837; H04W 36/0058

(57) ABSTRACT

An efficient cell selection and cell reselection mechanism in New Radio Unlicensed (NR-U) is proposed. An idle UE uses existing RSRP and RSRQ based metrics for cell selection and cell reselection. Besides the RSRP and RSRQ based metrics, the idle UE also uses some type of channel load metrics, which capture the channel load of unlicensed channels. In addition, as NE-U cells can be heavily loaded, some type of channel load metric is considered for measurement triggering of inter-frequency cell reselection. Further, it is proposed that the idle UE uses channel load metric to filter out the heavily loaded unlicensed cells, or reduce the rank of those cells. Additionally, the UE needs to check the cell's PLMN information to make sure that it selects or reselects a cell belonging to its own PLMN or an allowed PLMN.

### CROSS REFERENCE TO RELATED APPLICATIONS

This application claims priority under 35 U.S.C. § 119 from U.S. Provisional Application No. 62/753,115, entitled “Inter-Frequency Cell Reselection in NR-U,” filed on Oct. 31, 2018, the subject matter of which is incorporated herein by reference.

### TECHNICAL FIELD

The disclosed embodiments relate generally to wireless network communications, and, more particularly, to cell reselection design in 5G new radio unlicensed (NR-U) wireless communications systems.

### BACKGROUND

Third generation partnership project (3GPP) and Long-Term Evolution (LTE) mobile telecommunication systems provide high data rate, lower latency and improved system performances. With the rapid development of “Internet of Things” (IOT) and other new user equipment (UE), the demand for supporting machine communications increases exponentially. To meet the demand of this exponential increase in communications, additional spectrum (i.e. radio frequency spectrum) is needed. The amount of licensed spectrum is limited. Therefore, communications providers need to look to unlicensed spectrum to meet the exponential increase in communication demand. One suggested solution is to use a combination of licensed spectrum and unlicensed spectrum. This solution is referred to as “Licensed Assisted Access” or “LAA”. In such a solution, an established communication protocol such as LTE and 5G New Radio (NR) can be used over the licensed spectrum to provide a fist communication link, and LTE can also be used over the unlicensed spectrum to provide a second communication link.

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). In 5G NR, the base stations are also referred to as gNodeBs or gNBs. Cell selection is the procedure through which a UE picks up a specific cell for initial registration after power on. One major objective of cell selection is to quickly camp on to a candidate cell after initial power on. On the other hand, cell reselection is the mechanism to change cell after UE is camped on a cell and stays in radio resource control (RRC) IDLE mode. Cell reselection is a continuous process through which a UE, in RRC IDLE mode, searches and camps on a better cell than its current cell. Hence, as the purpose of cell selection and reselection have quite different objectives, the corresponding solutions will also be different.

Cell selection and reselection in NR-Unlicensed (NR-U) will be different from NR in two major aspects. First, unlike NR, in NR-U all cells in the unlicensed spectrum might belong to different Public Land Mobile Networks (PLMNs). In licensed NR spectrum, all cells in a particular frequency belong to the same PLMN. Naturally, a UE in NR normally camps on to the strongest cell of a particular carrier. However, in unlicensed NR-U spectrum, the strongest cell of a carrier might belong to a different PLMN. Thus, it is agreed upon in 3GPP specification that in NR-U, the UE will not camp on the strongest cell, if the strongest cell does not belong to its own PLMN. Second, deployment of unlicensed spectrum might be un-planned. Thus, while camping on an unlicensed carrier/cell, a UE might suffer from heavy channel load and interference from other unlicensed UEs and various network nodes including WiFi access points (APs) and WiFi stations. On the other hand, some neighboring unlicensed cell might have a relatively low load.

A solution is sought to explore some channel load metrics of unlicensed cells during cell selection and reselection in NR-U.

### SUMMARY

An efficient cell selection and cell reselection mechanism in New Radio Unlicensed (NR-U) is proposed. An idle UE uses existing RSRP and RSRQ based metrics for cell selection and cell reselection. Besides the RSRP and RSRQ based metrics, the idle UE also uses some type of channel load metrics, which capture the channel load of unlicensed channels. In addition, as NE-U cells can be heavily loaded, some type of channel load metric is considered for measurement triggering of inter-frequency cell reselection. Further, it is proposed that the idle UE uses channel load metric to filter out the heavily loaded unlicensed cells, or reduce the rank of those cells. Additionally, the UE needs to check the cell's PLMN information to make sure that it selects or reselects a cell belonging to its own PLMN or an allowed PLMN.

In one embodiment, a UE performs measurements of radio signals from multiple candidate cells over an unlicensed band in a mobile communication network. The UE determines reference signal received power (RSRP) and reference signal received quality (RSRQ) measurement results of each of the candidate cells. The UE estimates a channel load metric for each of the candidate cells. The UE performs cell selection using the RSRP and the RSRQ measurement results and the estimated channel load metric and thereby selecting a candidate cell to camp on.

In another embodiment, a UE camps on a selected cell in a new radio unlicensed (NR-U) mobile communication network and stays in an idle mode. The UE determines an inter-frequency measurement triggering condition based at least on an estimated channel load metric for each unlicensed candidate cell. The UE performs inter-frequency measurements for cell reselection upon satisfying the inter-frequency measurement triggering condition. The UE performs cell reselection using a cell ranking method that is based on reference signal received power (RSRP) measurement results as well as the estimated channel load metric for each unlicensed candidate cell.

Other embodiments and advantages are described in the detailed description below. This summary does not purport to define the invention. The invention is defined by the claims.

### BRIEF DESCRIPTION OF THE DRAWINGS

FIG. 1 illustrates an exemplary Licensed Assisted Access (LAA) 5G new radio (NR) wireless communication system that supports efficient cell selection and reselection using channel load metrics in NR-unlicensed (NR-U) in accordance with a novel aspect.

FIG. 2 is a simplified block diagram of a wireless transmitting device and a receiving device in accordance with embodiments of the present invention.

FIG. 3 illustrates a sequence flow between a UE and a base station for performing cell selection and reselection using channel load metrics in accordance with one novel aspect.

FIG. 4 illustrates a sequence flow between a UE and a base station for performing cell reselection using RSRP/RSRQ and channel load metrics in accordance with one novel aspect.

FIG. 5 is flow chart of a method of UE performing efficient cell selection and reselection in 5G NR-U in accordance with one novel aspect.

FIG. 6 is flow chart of a method of UE performing efficient cell reselection in 5G NR-U in accordance with one novel aspect.

### DETAILED DESCRIPTION

Reference will now be made in detail to some embodiments of the invention, examples of which are illustrated in the accompanying drawings.

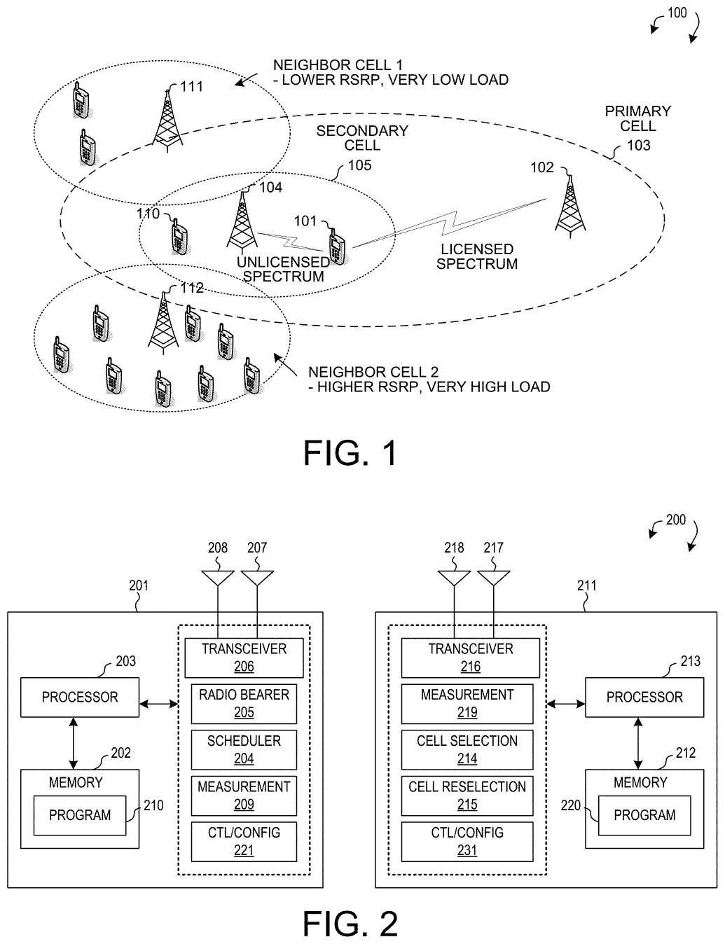

FIG. 1 illustrates an exemplary Licensed Assisted Access (LAA) 5G new radio (NR) wireless communication system 100 that supports efficient cell selection and reselection using channel load metrics in NR-unlicensed (NR-U) in accordance with a novel aspect. 5G NR wireless communications system 100 includes one or more wireless communication networks, and each of the wireless communication networks has base infrastructure units, such as 102, 104, 111, and 112. The base infrastructure units may also be referred to as an access point, an access terminal, a base station, eNB, gNB, or by other terminology used in the art. Each of the base stations 102 and 104 serves a geographic area. The geographic area served by wireless communications stations 102 and 104 overlaps in this example.

Base station 102 is a licensed base station that communicates with UE 101 via a licensed frequency band. In one example, base station 102 communicates with UE 101 via LTE wireless communication. Base station 102 provides wireless communication to multiple UEs within primary cell 103. Base station 104 is an unlicensed base station that communicates with UE 101 via an unlicensed frequency band. In one example, base station 104 communicates with UE 101 via LTE wireless communication. Base station 104 can communicate with multiple UEs with a secondary cell 105. Secondary cell 105 is also referred to as a “small cell”. Note that, FIG. 1 is an illustrative plot. The base station 102 and base station 104 can be co-located geographically.

The exponential growth in data consumption has created large bandwidth demands that cannot be met by current wireless systems. To meet this ever-increasing demand for data, new wireless systems with greater available bandwidth are needed. Licensed Assisted Access (LAA) wireless networks can be used to provide greater available bandwidth. An LAA network utilizes unlicensed frequency bands in addition to licensed frequency bands contemporaneously, thereby provided additional available bandwidth to the UEs in the wireless system. For example, UE 101 can benefit from simultaneous use of the licensed frequency band and the unlicensed frequency band in an LAA network. The LAA network not only provides additional bandwidth for greater overall data communication, but also provide consistent data connectivity due to the presence of two separate data links. Having multiple data links available increases the probability that the UE will be able to achieve proper data communication with at least one base station at any given moment.

In NR-Unlicensed (NR-U), not only downlink channels, but uplink channels are also transmitted over the 5 GHz unlicensed band. While utilization of the unlicensed spectrum provides more available bandwidth, the use of the unlicensed spectrum faces practical problems that need to be addressed. However, cell selection and reselection in NR-U will be different from NR in two major aspects. First, unlike NR, in NR-U all cells in the unlicensed spectrum might belong to different Public Land Mobile Networks (PLMNs). In licensed NR spectrum, all cells in a particular frequency belong to the same PLMN. Naturally, a UE in NR normally camps on to the strongest cell of a particular carrier. However, in unlicensed NR-U spectrum, the strongest cell of a carrier might belong to a different PLMN. Thus, it is agreed upon in 3GPP specification that in NR-U, the UE will not camp on the strongest cell, if the strongest cell does not belong to its own PLMN. Second, deployment of unlicensed spectrum might be un-planned. Thus, while camping on an unlicensed carrier/cell, a UE might suffer from heavy channel load and interference from other unlicensed UEs and various network nodes including WiFi access points (APs) and WiFi stations. On the other hand, some neighboring unlicensed cell might have a relatively low load.

Traditionally, cell selection and cell reselection are performed based on the measurement results on reference signal received power (RSRP) and reference signal received quality (RSRQ) of the serving cell and neighbor cells. In the example of FIG. 1, in addition to the serving cells 103 and 105, there are two neighboring cells for UE 101 and UE 110—neighbor cell 1 served by base station 111 and neighbor cell 2 served by base station 112. Neighbor cell 1 has lower RSRP, but very low load, neighbor cell 2 has higher RSRP, but very high load. Thus, it is better to explore some channel load metric to check and filter out the heavily loaded cells from cell selection. The same problem is pertinent into cell reselection as well, where measurement triggering and ranking of the candidate cells for cell reselection can be improved by considering channel load metrics of the unlicensed cells.

In accordance with one novel aspect, an efficient cell selection and cell reselection mechanism in NR-U is proposed. An idle UE uses existing RSRP and RSRQ based metrics for cell selection and cell reselection. Besides the RSRP and RSRQ based metrics, UE also uses some type of channel load metrics, which capture the channel load of unlicensed channels. Specifically, the proposed new cell selection condition is:

Srxlev>0 AND Squal>0 AND Sload<Sload_Threshold

where
Srxlev captures serving cell RSRP,
Squal captures serving cell RSRQ,
Sload captures the un-licensed channel load, based on channel occupancy, RSSI or any other suitable channel load metric,
Sload Threshold is configured/hard-coded.

In addition, as NE-U cells can be heavily loaded, some type of channel load metric is considered for measurement triggering of inter-frequency cell reselection. It is proposed that inter-frequency cell reselection measurement will not be triggered if:

Srxlev>SIntrasearchP AND Squal>SIntrasearchQ AND Sload<SIntrasearchCR

where
Srxlev captures serving cell RSRP,
SIntrasearchP captures RSRP threshold,
Squal captures serving cell RSRQ,
SIntrasearchQ captures RSRQ,
Sload captures the un-licensed channel load, based on channel occupancy, RSSI or any other suitable channel load metric,
SIntrasearchCR captures cell load threshold, received via SIB.

Furthermore, as some unlicensed cells might be overloaded with different unlicensed UEs and WiFi nodes and some other unlicensed cells might have a relatively low load, cell ranking criteria based only on RSRP can suffer from heavy interference, leading to increased possibility of LBT failure and RACH failure. Accordingly, it is proposed that idle UE uses channel load metric to filter out the heavily loaded unlicensed cells, or reduce the rank of those cells. Note that, additionally the UE needs to check the cell's PLMN information to make sure that it selects or reselects a cell belonging to its own PLMN; otherwise the UE will not consider the cell and choose next candidate cell (e.g., typically the next strongest cell) to be selected or reselected.

FIG. 2 is a simplified block diagram of wireless devices 201 and 211 in accordance with embodiments of the present invention. For wireless device 201 (e.g., a transmitting device), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a receiving device), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes a radio bearer handling module 205, a scheduler 204, a measurement module 209, and a control and configuration circuit 221. Wireless device 211 is a UE that includes a measurement module 219, a cell selection handling circuit 214, a cell reselection handling circuit 215, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow transmitting device 201 and receiving device 211 to perform embodiments of the present invention.

In one example, the base station 201 establishes a data radio bearer with the UE 211 via radio bearer handing circuit 205, schedules downlink and uplink transmission for UEs via scheduler 204, performs measurements and receives measurement reports via measurement module 209, and provides configuration information to UEs via configuration circuit 221. The UE 211 performs measurements and reports measurement report via measurement module 219, performs cell selection via cell selection handling circuit 214, performs uplink cell reselection via cell reselection handling circuit 215, and obtains control and configuration information via control and configuration circuit 231. In accordance with one novel aspect, UE 211 considers channel load metric of unlicensed cells in the process of cell selection and cell reselection.

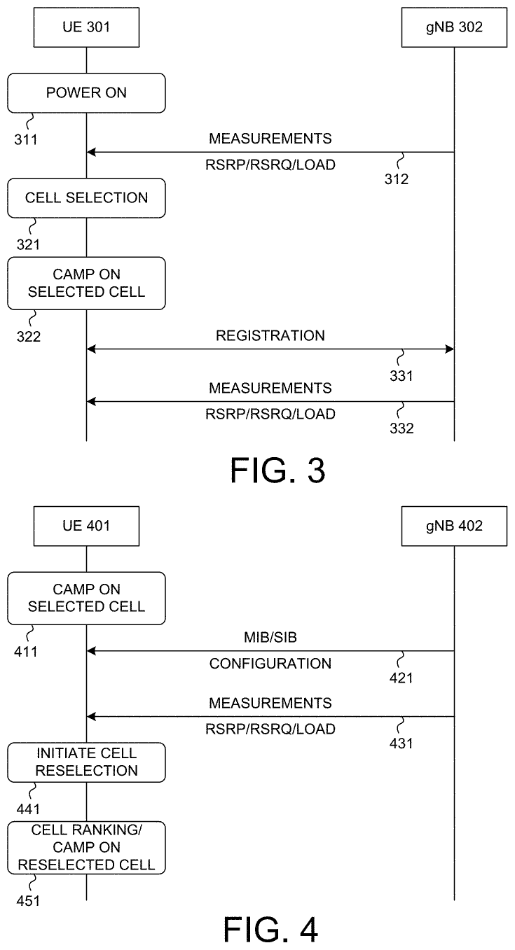

FIG. 3 illustrates a sequence flow between a UE and a base station for performing cell selection using RSRP/RSRQ and channel load metrics in accordance with one novel aspect. In step 311, UE 301 is powered on. In step 312, UE 301 performs measurements on received radio signals (e.g., reference signals) from all neighbor candidate cells as potential serving cells. The measurement results may include RSRP and RSRQ of the received reference signals. The measurement results may further include some kind of channel load metrics, which captures the channel load of unlicensed channels. In step 321, UE 301 performs cell selection to select a candidate cell as its serving cell to camp on. Cell selection is the procedure through which a UE picks up a specific cell for initial registration after power on. One major objective of cell selection is to quickly camp on to a selected candidate cell after initial power on.

In accordance with one novel aspect, the cell selection is performed based on RSRP, RSRQ, and channel load of unlicensed channels. For example, the channel load is based on channel occupancy (CO), received signal strength indication (RSSI), or any other suitable channel load metric. In one example, the channel occupancy equals to the percentage of measurement samples with RSSI that is higher than a threshold. In one example, UE considers a candidate cell only if 1) RSRP is higher than a threshold, and 2) RSRQ is higher than a threshold, and 3) the channel load is lower than a threshold. The different thresholds can be hardcoded or configured by the network. Note that UE 301 also needs to make sure that the selected cell belongs to its own PLMN. Alternatively, an NR-U UE can manually select a specific cell (e.g., in un-planned deployment) and after successful camp/access. UE can consider this cell as the highest priority cell for a specific period of time. In step 322, UE 301 camps on the selected cell. In step 331, UE 301 performs registration to access the network through its serving base station gNB 302. In step 332, idle mode UE 301 continues to perform measurements, e.g., for cell reselection.

FIG. 4 illustrates a sequence flow between a UE and a base station for performing cell reselection using RSRP/RSRQ and channel load metrics in accordance with one novel aspect. In step 411, UE 401 camps on a selected cell after performing cell selection. In step 421, UE 401 receives broadcasted information from the serving gNB 402, including Master information block and System information block (MIB/SIB). The MIB/SIB may include various control and configuration information, e.g., different thresholds and priorities for cell selection and reselection. In step 431, UE 401 performs both intra-frequency and inter-frequency measurements on received radio signals from all neighbor cells and the serving cell upon satisfying the measurement triggering condition. The measurement results may include RSRP and RSRQ of the received radio signals. The measurement results may further include some kind of channel load metrics, which captures the channel load of unlicensed channels.

In step 441, UE 401 performs cell reselection. After cell selection is complete, if the channel conditions of the current serving cell fall below some certain thresholds, UE initiates cell reselection, i.e., searching for cells with better coverage. Cell reselection is the mechanism to change cell after UE is camped on a cell and stays in radio resource control (RRC) IDLE mode. Cell reselection is a continuous process through which a UE, in RRC IDLE mode, searches and camps on a better cell than its current cell. As NR-U cells can be heavily loaded, some type of channel load metric is considered for measurement triggering of inter-frequency cell reselection. The channel load metric may be based on channel occupancy (CO), received signal strength indication (RSSI), or any other suitable channel load metric. In one example, the inter-frequency measurements will not be triggered if 1) RSRP of the serving cell is greater than a threshold, and 2) RSRQ of the serving cell is greater than a threshold, and 3) the channel load of the serving cell is less than a threshold. The different thresholds can be predefined or can be received from SIB. In addition, for inter-frequency measurements, UE 401 receives the absolute priorities of different frequencies from SIB and uses these priorities similar to licensed NR.

In step 451, after measurements, UE 401 needs to perform cell ranking for the purpose of cell reselection. However, as some unlicensed cells might be overloaded with different unlicensed UEs and WiFi nodes and some other unlicensed cell might have a relatively light load, cell ranking criteria based only on RSRP can suffer from heavy interference, leading to increased possibility of Listen Before Talk (LBT) failure and Random-Access Channel (RACH) failure. Accordingly, it is proposed that idle UE uses channel load metric to filter out the heavily loaded unlicensed cells, or reduce the rank of those cells. The channel load metric may be based on channel occupancy (CO), received signal strength indication (RSSI), or any other suitable channel load metric. Similar to initial cell selection, before finalizing the inter-cell reselection, UE also needs to check if the reselected cell belongs to an allowed PLMN; otherwise the UE will bar the cell for reselection.

Specifically, a function (f) can be defined for cell ranking criteria Rₙ in cell reselection for unlicensed cells. Specifically, cell ranking criteria R_{n,unlicensed} for unlicensed cells can be updated by multiplying Rₙ with the function f. In a first example, lightly loaded cells can keep the ranking value as defined in formula (1); in a second example, heavily loaded cells can be filtered out (removed) as defined in formula (2), and in a third example, heavily loaded cells can be reduced in ranking as formula (3).

R_{n,unlicensed}=Rₙ*ƒ, where Rₙ=Q_{meas,n}+Q_{offset}−Q_{offsettemp}

where
Q_{meas,n} indicates RSRP measurement quantity used in cell reselections.
Q_{offset} indicates offset associated with inter-frequency and inter-cell measurements
   The function f can be defined as an “indicator function” having value 1 or 0 with the following conditions:

ƒ=1, if measured channel occupancy in neighbouring cell CRₙ≤SIntrasearchCR; (1)

ƒ=0, if measured channel occupancy in neighbouring cell CRₙ>SIntrasearchCR; (2)

Alternatively, instead of an indicator function, ƒ can also be defined as the ratio of SIntrasearchCR and CRₙ, i.e.

ƒ=Snon-IntrasearchCR/CRₙ, (3)

where
CRₙ indicates the cell load in the corresponding cell
Snon-IntrasearchCR indicates cell load threshold, received via SIB

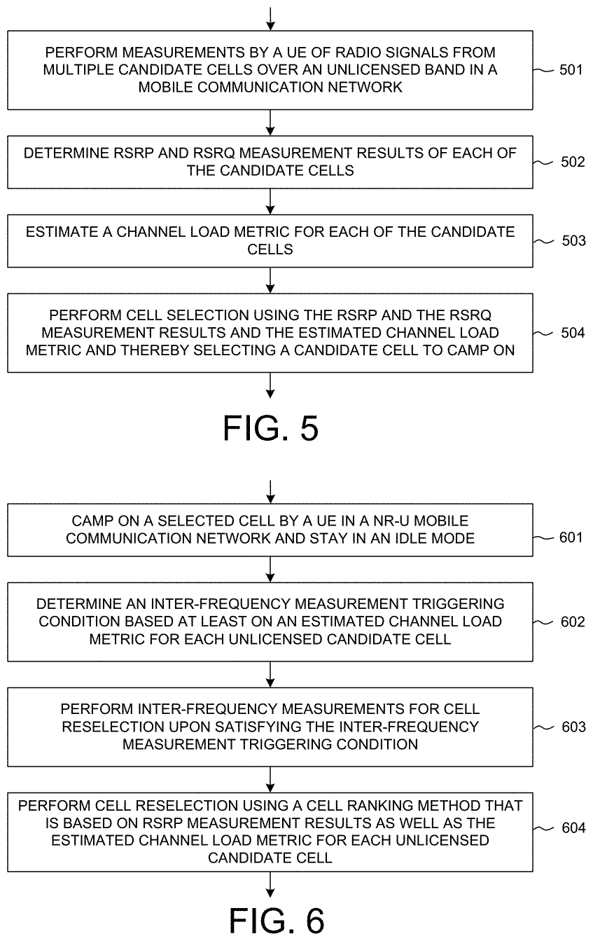

FIG. 5 is flow chart of a method of UE performing efficient cell selection in 5G NR-U in accordance with one novel aspect. In step 501, a UE performs measurements of radio signals from multiple candidate cells over an unlicensed band in a mobile communication network. In step 502, the UE determines reference signal received power (RSRP) and reference signal received quality (RSRQ) measurement results of each of the candidate cells. In step 503, the UE estimates a channel load metric for each of the candidate cells. In step 504, the UE performs cell selection using the RSRP and the RSRQ measurement results and the estimated channel load metric and thereby selecting a candidate cell to camp on.

FIG. 6 is flow chart of a method of UE performing efficient cell reselection in 5G NR-U in accordance with one novel aspect. In step 601, a UE camps on a selected cell in a new radio unlicensed (NR-U) mobile communication network and stays in an idle mode. In step 602, the UE determines an inter-frequency measurement triggering condition based at least on an estimated channel load metric for each unlicensed candidate cell. In step 603, the UE performs inter-frequency measurements for cell reselection upon satisfying the inter-frequency measurement triggering condition. In step 604, the UE performs cell reselection using a cell ranking method that is based on reference signal received power (RSRP) measurement results as well as the estimated channel load metric for each unlicensed candidate cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
performing measurements by a user equipment (UE) of radio signals from multiple candidate cells over an unlicensed band in a mobile communication network;
determining reference signal received power (RSRP) and reference signal received quality (RSRQ) measurement results of each of the candidate cells;
estimating a channel load metric for each of the candidate cells; and
performing cell selection using the RSRP and the RSRQ measurement results and the estimated channel load metric and thereby selecting a candidate cell to camp on.

2. The method of claim 1, wherein the channel load metric is estimated based on a received signal strength indication (RSSI) of a corresponding cell.

3. The method of claim 1, wherein the channel load metric is estimated based on a channel occupancy (CO) of a corresponding cell.

4. The method of claim 1, wherein the channel load metric of the selected candidate cell is less than a channel load threshold.

5. The method of claim 4, wherein the channel load threshold is configured by the network or pre-defined for the UE.

6. The method of claim 1, wherein the UE further checks whether a candidate cell belongs to its own Public Land Mobile Network (PLMN) for the cell selection.

7. A method comprising:
camping on a selected cell by a user equipment (UE) in a new radio unlicensed (NR-U) mobile communication network and staying in an idle mode;
determining an inter-frequency measurement triggering condition based at least on an estimated channel load metric for each unlicensed candidate cell;
performing inter-frequency measurements for cell reselection upon satisfying the inter-frequency measurement triggering condition; and
performing cell reselection using a cell ranking method that is based on reference signal received power (RSRP) measurement results as well as the estimated channel load metric for each unlicensed candidate cell.

8. The method of claim 7, wherein the channel load metric is estimated based on a received signal strength indication (RSSI) or a channel occupancy (CO) for each candidate cell.

9. The method of claim 7, wherein the cell ranking method involves updating a cell ranking for an unlicensed cell based on a cell load threshold.

10. The method of claim 9, wherein the cell load threshold is configured by the network.

11. The method of claim 9, wherein the cell ranking method involves removing a heavy load cell with a cell load that is higher than the cell load threshold.

12. The method of claim 9, wherein the cell ranking method involves proportionally reducing a cell ranking for a heavy load cell having a higher cell load as compared to the cell load threshold.

13. The method of claim 7, wherein the UE further checks whether a candidate cell belongs to its own Public Land Mobile Network (PLMN) for the cell reselection.

14. A User Equipment (UE), comprising:
a cell selection handling circuit that camps on a selected cell in a new radio unlicensed (NR-U) mobile communication network, wherein the UE is in an idle mode;
a control circuit that determines an inter-frequency measurement triggering condition based at least on an estimated channel load metric for each candidate cell;
a measurement circuit that performs inter-frequency measurements for cell reselection upon satisfying the inter-frequency measurement triggering condition; and
a cell reselection handling circuit that performs cell reselection using a cell ranking method that is based on reference signal received power (RSRP) measurement results as well as the estimated channel load metric for each unlicensed candidate cell.

15. The UE of claim 14, wherein the channel load metric is estimated based on a received signal strength indication (RSSI) or a channel occupancy (CO) for each candidate cell.
